(19) United States
(12) Patent Application Publication
(10) Pub. No.: US 2021/0176684 A1
(43) Pub. Date: Jun. 10, 2021

(54) TERMINAL CAMPING METHOD, INFORMATION TRANSMISSION METHOD, TERMINAL, AND NETWORK DEVICE

(71) Applicant: VIVO MOBILE COMMUNICATION CO., LTD., Dongguan (CN)

(72) Inventors: Boubacar KIMBA DIT ADAMOU, Dongguan (CN); Xiaodong YANG, Dongguan (CN)

(73) Assignee: VIVO MOBILE COMMUNICATION CO., LTD., Dongguan (CN)

(21) Appl. No.: 17/183,331

(22) Filed: Feb. 23, 2021

Related U.S. Application Data
(63) Continuation of application No. PCT/CN2019/104342, filed on Sep. 4, 2019.

(30) Foreign Application Priority Data
Sep. 5, 2018 (CN) 201811033508.6

(51) Int. Cl. H04W 36/08; H04W 36/00; H04W 48/20

(52) U.S. Cl. CPC H04W 36/08; H04W 48/20; H04W 36/0077

(57) ABSTRACT

Embodiments of the present disclosure provide a terminal camping method, information transmission method, terminal, and network device. The terminal camping method may be applied to a terminal, and include obtaining assistance information for cell reselection and camping, and performing cell reselection and camping according to first uplink data and the assistance information when the terminal is in an inactive state. The first uplink data may include at least one of uplink data of a secondary base station or uplink data of a master base station.

### CROSS-REFERENCE TO RELATED APPLICATIONS

This application is a bypass continuation of PCT Application No. PCT/CN2019/104342 filed Sep. 4, 2019, which claims priority to Chinese Patent Application No. 201811033508.6 filed in China on Sep. 5, 2018, both of which are incorporated herein by reference in their entireties.

### TECHNICAL FIELD

The present disclosure relates to the field of communications technologies, and in particular, to a terminal camping method, an information transmission method, a terminal, and a network device.

### BACKGROUND

In a dual connectivity (DC) scenario, a secondary base station (Secondary Node, SN) connected with user equipment (UE, also known as a terminal) can support a split bearer or an SN terminated bearer. When the UE supports a split bearer or an SN terminated bearer in the SN, if the UE has no data stream, a network can suspend the UE. In the suspend state, if the UE has downlink data, the network can page the UE and make the UE initiate a random access channel (RACH) in the SN.

However, in the dual connectivity scenario, when the terminal is in the inactive state, a cell of a base station on which the terminal camps is not fixed. If uplink data arrives at the terminal, when the cell on which the terminal camps does not meet an uplink data sending condition, it cannot be ensured that an uplink service is processed in time.

### SUMMARY

The following solutions are used in the present disclosure.

According to a first aspect, an embodiment of the present disclosure provides a terminal camping method, applied to a terminal. The method includes: obtaining assistance information for cell reselection and camping; and when the terminal is in an inactive state, performing cell reselection and camping according to first uplink data and the assistance information, where the first uplink data includes: at least one of uplink data of a secondary base station or uplink data of a master base station.

According to a second aspect, an embodiment of the present disclosure provides an information transmission method, applied to a network device. The method includes: sending assistance information to a terminal, where the assistance information is used by the terminal to perform cell reselection and camping when the terminal is in an inactive state and has first uplink data.

According to a third aspect, an embodiment of the present disclosure provides a terminal. The terminal includes: an obtaining module, configured to obtain assistance information for cell reselection and camping; and a processing module, configured to: when the terminal is in an inactive state, perform cell reselection and camping according to first uplink data and the assistance information, where the first uplink data includes: at least one of uplink data of a secondary base station or uplink data of a master base station.

According to a fourth aspect, an embodiment of the present disclosure provides a terminal, including: a memory, a processor, and a program stored in the memory and executable on the processor, where the program, when executed by the processor, implements the steps of the terminal camping method.

According to a fifth aspect, an embodiment of the present disclosure provides a network device, including: a sending module, configured to send assistance information to a terminal, where the assistance information is used by the terminal to perform cell reselection and camping when the terminal is in an inactive state and has first uplink data.

According to a sixth aspect, an embodiment of the present disclosure provides a network device, including: a memory, a processor, and a program stored in the memory and executable on the processor, where the program, when executed by the processor, implements the steps of the information transmission method.

According to a seventh aspect, an embodiment of the present disclosure provides a computer-readable storage medium, where the computer-readable storage medium stores a program, and the program, when executed by a processor, implements the steps of the terminal camping method or the steps of the information transmission method.

### BRIEF DESCRIPTION OF DRAWINGS

FIG. 1 is a schematic flowchart of a terminal camping method applied to a terminal according to an embodiment of the present disclosure;

FIG. 2 is a schematic flowchart of an information transmission method applied to a network device according to an embodiment of the present disclosure;

FIG. 3 is a schematic diagram of modules of a terminal according to an embodiment of the present disclosure;

FIG. 4 is a structural block diagram of a terminal according to an embodiment of the present disclosure;

FIG. 5 is a schematic diagram of modules of a network device according to an embodiment of the present disclosure; and

FIG. 6 is a structural block diagram of a network device according to an embodiment of the present disclosure.

### DETAILED DESCRIPTION

To make the objectives, technical solutions, and advantages of the present disclosure clearer, the following further describes the present disclosure in detail with reference to the accompanying drawings and specific embodiments.

Before the embodiments of the present disclosure are described, some concepts used in the following description are explained first.

Dual connectivity is a technology introduced in long term evolution (Long Term Evolution, LTE) and will also be used in new radio (New Radio, NR). It means that UE can connect to two base stations at the same time, and the two base stations provide data receiving and transmitting services for the UE at the same time. Because radio resources of the two base stations may be used at the same time, the service data transmission rate of the UE can be doubled.

There is a signaling interface between the two base stations serving the same UE, and the interface can exchange configuration information related to the UE.

The serving base stations of the dual-connectivity UE may belong to a same radio access technology (RAT), for example, are two evolved NodeBs (eNBs) of LTE, or may belong to different RATs, for example, are one LTE eNB and one NR gNB. The present disclosure can be applied to any combination of dual-connectivity base stations, and types of dual-connectivity base stations are not limited.

One of the serving base stations of the dual-connectivity UE is a master base station (Master Node, MN) and the other is a secondary base station (Secondary Node, SN). Each base station can support the carrier aggregation (CA) technology. The network configures two special cells for the dual-connectivity UE, that is, a serving cell of the MN is configured as a primary serving cell (PCell) of the UE, and a serving cell of the SN is configured as a primary secondary serving cell (Primary Secondary Cell, PSCell). Other cells of the MN and the SN that serve the UE are secondary serving cells (Secondary Cell, SCell) of the UE.

Multi-connectivity means that more than two base stations provide services for same UE. The present disclosure is also applicable to multi-connectivity and does not limit the type of a multi-connectivity base station.

Similar to dual connectivity, in multi-connectivity, one of the serving base stations connected with UE is an MN or provides a master serving cell group (Master Cell Group, MCG), and the remaining is an SN or provides a secondary serving cell group (Secondary Cell Group).

The UE can support a split bearer or an SN terminated bearer in the SN. When the UE supports a split bearer or an SN terminated bearer in the SN, if the UE has no data stream, a network can suspend the UE. In the suspend state, if the UE has downlink data, the network can page the UE and make the UE initiate a random access procedure in the SN. The present disclosure can resolve the problem that when the SN supports a split bear or an SN terminated bear and the UE is in a suspend state, if uplink data arrives at the UE, how to ensure that the UE accesses the SN as soon as possible to perform a data service.

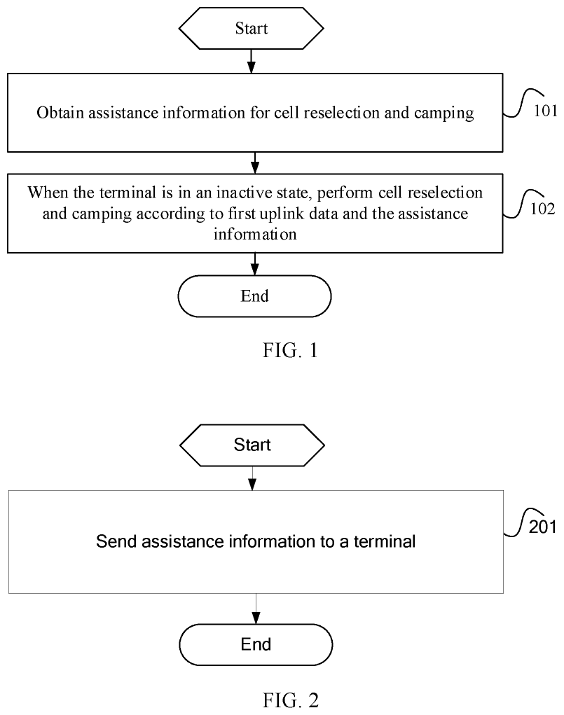

As shown in FIG. 1, an embodiment of the present disclosure provides a terminal camping method, applied to a terminal in a dual connectivity state or in a multi-connectivity state, and including step 101 and step 102.

Step 101: Obtain assistance information for cell reselection and camping.

It should be noted that the assistance information includes: at least one of offset information of cell reselection parameter (that is, offset) or cell reselection priority information.

Step 102: After the terminal is in an inactive state, perform cell reselection and camping according to first uplink data and the assistance information.

It should be noted that the first uplink data includes: uplink data of a secondary base station and/or uplink data of a master base station. The cell that is reselected and camped on is used to receive the first uplink data.

In the embodiments of the present disclosure, when the terminal is in the inactive state, when there is the first uplink data, the assistance information for cell reselection and camping is used to reselect and camp on a cell for receiving the first uplink data. It can be ensured that in the inactive state, the terminal can camp on a suitable cell as soon as possible for an uplink service.

It should be noted that the terminal can obtain the assistance information before entering the inactive state (for example, a connected state), or can obtain the assistance information after entering the inactive state. The assistance information can be notified to the terminal by the network device, or can be pre-defined information, for example, can be information specified by a protocol, or can be information preset in the terminal.

Further, when the assistance information is obtained from the network, the assistance information for cell reselection and camping is obtained in one of the following manners:

A1: obtaining the assistance information carried in a suspending (suspend) message sent by a first base station; or

A2: receiving the assistance information broadcasted by a first base station.

Specifically, the first base station includes: a master base station or a secondary base station.

It should be noted herein that because a control plane of the terminal is located in the master base station in the dual connectivity network architecture, the master base station can notify the terminal of the assistance information before or after the terminal enters the inactive state. In the future application, the control plane of the terminal can also be located in the secondary base station. Therefore, the secondary base station can also notify the terminal of the assistance information before or after the terminal enters the inactive state.

It should be noted that a specific implementation of step 102 is: when the terminal is in the inactive state, performing, when the first uplink data arrives, if a cell on which the terminal currently camps cannot transmit the first uplink data, cell reselection and camping according to the first uplink data and the assistance information.

It should be noted that when the terminal is in the inactive state, the terminal selects a cell for camping. When uplink data arrives, the terminal knows that the cell currently camped on cannot transmit the uplink data, and cell reselection and camping needs to be performed. If the terminal knows that the cell currently camped on can transmit the uplink data, the terminal can directly transmit the uplink data without performing the process of cell reselection and camping.

It should be further noted that according to the assistance information, the terminal may choose to camp on a cell for receiving the uplink data. Specifically, when the first uplink data is uplink data of the master base station, if the terminal in the inactive state camps on a cell of a non-master base station, the terminal reselects and camps on a cell of the master base station according to first uplink data and the assistance information. When the first uplink data is uplink data of the secondary base station, if the terminal in the inactive state camps on a cell of a non-secondary base station, the terminal reselects and camps on a cell of the secondary base station according to first uplink data and the assistance information.

It should also be noted that in the above case, if the assistance information is obtained from a network side, the terminal first stores the assistance information when the terminal is in the inactive state.

It should be noted that the specific implementation process of the above step 102 is as follows:

according to the first uplink data, determining at least one first candidate cell for reselection and camping; and

reselecting a first cell from the at least one first candidate cell by using the assistance information configured for the first candidate cell, and camping on the first cell.

It should be noted that the first candidate cell is all cells that meet a transmission requirement (that is, capable of transmitting the first uplink data), and the first cell is one of first candidate cells that meets a camping condition.

The following describes reselection and camping by the terminal by using different assistance information.

1. The assistance information includes offset information of cell reselection parameter (that is, offset).

When the terminal obtains the offset information of cell reselection parameter, the terminal first determines cells that can be used as candidate cells, then takes the offset information into consideration during calculation when selecting from the candidate cells, and then selects the first cell from the candidate cells, to increase the selection opportunity of the terminal from the candidate cells.

It should be noted that the cell reselection parameter can be reference signal received power (RSRP), reference signal received quality (RSRQ), and the like.

For example, in general, the terminal camps on a cell 1 of the master base station, while the secondary base station of the terminal has a cell 2 and a cell 3. If uplink data of the secondary base station of the terminal arrives, the terminal should use the offset information to preferentially reselect the cell 2 or the cell 3 for camping. In general, only when the signal strength of the cell 2 or the cell 3 that is measured by the terminal is higher than a specific value of the signal strength of the cell 1 (for example, 5 dB higher than the reference signal received power), the terminal reselects the cell 2 or the cell 3. However, because the uplink data of the secondary base station needs to be sent, offset information (for example, 3 dB) is added to the signal strength of the cell 2 and the cell 3, so that the signal strength of the cell 2 or the cell 3 is higher than the signal strength (for example, 2 dB) of the cell 1, and the terminal can reselect the cell 2 or the cell 3.

It should be further noted that the offset information can be configured for cells, that is, different cells may have different offset parameters; or the offset information can be set for frequencies, that is, different frequencies may have different offset parameters.

2. The assistance information includes cell reselection priority information.

In this case, the terminal first determines cells that can be used as candidate cells, and then selects the first cell from the candidate cells by using the reconfigured reselection priority information of the candidate cells, so as to increase the selection opportunity of the terminal from the candidate cells. It should be noted that as long as one of the candidate cells meets a cell camping criterion S, the terminal directly camps on the cell.

For example, the secondary base station of the terminal has the cell 2 and the cell 3. When the uplink data of the secondary base station of the terminal arrives, the terminal directly attempts to camp on the cell 2 or the cell 3 according to the reselection priority information. As long as the cell 2 or the cell 3 meets the cell camping criterion S, the terminal directly camps on the cell 2 or the cell 3.

It should be further noted that the cell reselection priority information can be configured for cells, that is, different cells have different reselection priority information; or the cell reselection priority information can be set for frequencies, that is, different frequencies have different reselection priority information.

It should be further noted that after the terminal camps on a cell meeting the transmission requirement, the terminal also performs the following step:

initiating a random access process to the cell, and sending the first uplink data to the cell.

It should be noted that the above is a data transmission process of the terminal when the terminal camps on a cell meeting the transmission requirement. When the terminal does not camp on a cell meeting the transmission requirement, the terminal also performs the following step:

When the first uplink data arrives, the existence of the first uplink data is indicated to the master base station. When the first uplink data is the uplink data of the secondary base station, the master base station sends a bearer establishment notice to the secondary base station, and the secondary base station establishes an uplink data bear for the terminal. The first uplink data is sent to the secondary base station through the uplink data bear.

It should be noted that a specific implementation of indicating the existence of uplink data to the master base station includes at least one of the following manner B1 or B2:

B1. Send a resume message to the master base station, where the resume message carries uplink data indication information.

B2. Initiate a connection to the master base station in a predefined manner.

The pre-defined manner includes: using a pre-defined preamble or using a pre-defined random access channel.

Specifically, an implementation of using a pre-defined preamble is as follows: for example, a preamble 1 is used to indicate that the uplink data of the master base station arrives at the terminal, and a preamble 2 is used to indicate that the uplink data of the secondary base station arrives at the terminal. After the base station receives the corresponding preamble, when it is determined, according to the preamble, that the uplink data of the master base station arrives, a bearer between the base station and the terminal is directly established. When it is determined, according to the preamble, that the uplink data of the secondary base station arrives, a bearer establishment notice is sent to the secondary base station, and the secondary base station establishes the uplink data bearer for the terminal after receiving the bearer establishment notice, and then can receive uplink data sent by the terminal through the uplink data bearer.

Specifically, an implementation of using a pre-defined RACH is as follows: a RACH 1 is used to indicate that the uplink data of the master base station arrives at the terminal, and a RACH 2 is used to indicate that the uplink data of the secondary base station arrives at the terminal. After receiving a resource sent through the RACH, when the base station determines, according to the RACH, that the uplink data of the master base station arrives, the bearer between the base station and the terminal is directly established. When it is determined, according to the RACH, that the uplink data of the secondary base station arrives, a bearer establishment notice is sent to the secondary base station. After the secondary base station receives the bearer establishment notice, the secondary base station establishes the uplink data bearer for the terminal, and then can receive the uplink data sent by the terminal through the uplink data bearer.

The following uses an example in which the terminal sends the uplink data of the secondary base station, to describe the implementation process of the embodiments of the present disclosure in detail in a specific application as follows.

When the terminal has no data service on a master serving cell group bearer (MCG bearer), or a secondary serving cell group bearer (SCG bearer), or a split bearer (split bearer), the network suspends the terminal and the terminal enters an inactive state (INACTIVE). Before or after the terminal enters the inactive state (INACTIVE), the network can deliver the assistance information to the terminal for reselection and camping, so that the terminal reselects and camps on a cell of the secondary base station. The network can deliver the assistance information in the following manner: carrying the assistance information in a suspend message or broadcasting the assistance information.

After the terminal obtains the assistance information, the terminal can first store the assistance information after entering the inactive state. When the uplink data of the secondary base station arrives at the terminal, if the terminal currently does not camp on the cell of the secondary base station, the terminal reselects and camp on the cell of the secondary base station, initiates a random access process, and transmits the uplink data.

If the terminal cannot camp on the cell of the secondary base station, when the uplink data of the secondary base station arrives at the terminal, the terminal indicates to the master base station that there is uplink data of the secondary base station. A specific indication manner includes one of the following manners D1 to D3:

D1. The terminal adds uplink data indication information to a resume (resume) message sent to the master base station.

D2. The terminal uses a dedicated preamble to initiate a connection to the master base station. For example, the preamble 1 indicates that the uplink data of the master base station arrives at the terminal, while the preamble 2 indicates that the uplink data of the secondary base station arrives at the terminal.

D3. The terminal uses a dedicated RACH resource to initiate a connection to the master base station to distinguish data of base stations.

The master base station receives the indication from the terminal, and when it indicates that the uplink data of the secondary base station arrives, the master base station notifies the secondary base station to establish an uplink data-related bearer for the terminal.

It should also be noted that when the terminal has no data service on an MCG bearer, or an SCG bearer, or a split bearer, the network suspends the terminal and the terminal enters the inactive state. When uplink data of the secondary base station arrives, if the terminal does not camp on the cell of the secondary base station, the terminal can directly indicate to the master base station that there is uplink data of the secondary base station, and the master base station notifies the secondary base station to establish the uplink data bearer to perform the uplink data transmission process.

It should be noted that in the embodiments of the present disclosure, when the terminal is in the inactive state, when there is the first uplink data, the assistance information for cell reselection and camping is used to reselect and camp on a cell for receiving the first uplink data. It can be ensured that in the inactive state, the terminal can camp on a suitable cell as soon as possible for an uplink service and the timeliness of network communication is ensured.

Specifically, as shown in FIG. 2, FIG. 2 is a schematic flowchart of an information transmission method according to an embodiment of the present disclosure. The information transmission method is applied to a network device, and includes:

Step 201: Send assistance information to a terminal.

The assistance information is used by the terminal to perform cell reselection and camping when the terminal is in an inactive state and has first uplink data.

Specifically, step 201 is used to:

before the terminal enters the inactive state, send the assistance information to the terminal; or

after the terminal enters the inactive state, send the assistance information to the terminal.

Specifically, step 201 includes one of the following manners:

sending a suspending message to the terminal, where the suspending message carries the assistance information; or

broadcasting the assistance information to the terminal

It should be noted that the network device is a master base station or a secondary base station.

It should be noted that all the descriptions about the network device in the foregoing embodiments are applicable to the embodiment of the information transmission method, and the same technical effect thereof can be achieved.

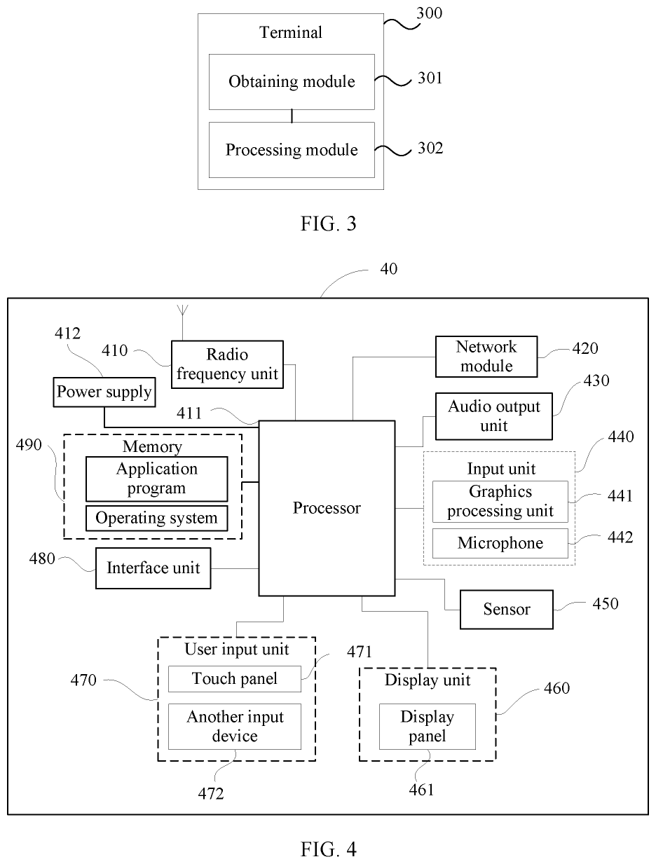

Referring to FIG. 3, an embodiment of the present disclosure provides a terminal 300, including:

an obtaining module 301, configured to obtain assistance information for cell reselection and camping; and

a processing module 302, configured to: when the terminal is in an inactive state, perform cell reselection and camping according to first uplink data and the assistance information, where

the first uplink data includes: uplink data of a secondary base station and/or uplink data of a master base station.

Specifically, the obtaining module 301 is configured to:

before entering the inactive state, obtain the assistance information for cell reselection and camping; or

after entering the inactive state, obtain the assistance information for cell reselection and camping.

Optionally, the assistance information is pre-defined information.

Optionally, the obtaining module 301 includes one of the following units:

an obtaining unit, configured to obtain the assistance information carried in a suspending message sent by a first base station; or

a receiving unit, configured to receive the assistance information broadcasted by a first base station, where

the first base station includes: a master base station or a secondary base station.

Specifically, the processing module 302 is configured to:

when the terminal is in the inactive state, when the first uplink data arrives, if a cell on which the terminal currently camps cannot transmit the first uplink data, perform cell reselection and camping according to the first uplink data and the assistance information.

Further, when the first uplink data is uplink data of the master base station, the processing module 302 is configured to:

if the terminal in the inactive state camps on a cell of a non-master base station, reselect and camp on a cell of the master base station according to first uplink data and the assistance information.

Further, when the first uplink data is uplink data of the secondary base station, the processing module 302 is configured to:

if the terminal in the inactive state camps on a cell of a non-secondary base station, reselect and camp on a cell of the secondary base station according to first uplink data and the assistance information.

Further, before the processing module 302 performs, when the first uplink data arrives, if a cell on which the terminal currently camps cannot transmit the first uplink data, cell reselection and camping according to the first uplink data and the assistance information, the terminal further includes:

a storage module, configured to store the assistance information.

Optionally, the processing module 302 includes:

a determining unit, configured to: according to the first uplink data, determine at least one first candidate cell for reselection and camping; and

a processing unit, configured to reselect a first cell from the at least one first candidate cell by using the assistance information configured for the first candidate cell, and camp on the first cell.

Specifically, the assistance information includes: offset information of cell reselection parameter and/or cell reselection priority information.

Further, the assistance information is a cell-specific configuration; or the assistance information is a frequency-specific configuration.

It should be noted that this terminal embodiment provides the terminal corresponding to the terminal camping method applied to the terminal, all implementations in the foregoing embodiments are applicable to this terminal embodiment, and the same technical effect thereof can be achieved.

FIG. 4 is a schematic diagram of a hardware structure of a terminal according to an embodiment of the present disclosure.

The terminal 40 includes, but is not limited to: components such as a radio frequency unit 410, a network module 420, an audio output unit 430, an input unit 440, a sensor 450, a display unit 460, a user input unit 470, an interface unit 480, a memory 490, a processor 411, and a power supply 412. A person skilled in the art may understand that the structure of the terminal shown in FIG. 4 does not constitute a limitation to the terminal. The terminal may include more or fewer components than those shown in the figure, or some components may be combined, or there may be a different component arrangement. In this embodiment of the present disclosure, the terminal includes, but is not limited to, a mobile phone, a tablet computer, a notebook computer, a palmtop computer, a vehicle-mounted terminal, a wearable device, a pedometer, or the like.

The processor 411 is configured to: obtain assistance information for cell reselection and camping; and when the terminal is in an inactive state, perform cell reselection and camping according to first uplink data and the assistance information, where

the first uplink data includes: uplink data of a secondary base station and/or uplink data of a master base station.

In the embodiments of the present disclosure, when the terminal is in the inactive state, when there is the first uplink data, the assistance information for cell reselection and camping is used by the terminal to reselect and camp on a cell for receiving the first uplink data. It can be ensured that in the inactive state, the terminal can camp on a suitable cell as soon as possible for an uplink service and the timeliness of network communication is ensured.

It should be understood that, in this embodiment of the present disclosure, the radio frequency unit 410 can be configured to receive and transmit information, or receive and transmit signals during a call. Specifically, the radio frequency unit 410 receives downlink data from a network device, and transmits the downlink data to the processor 411 for processing; and in addition, transmits uplink data to the network device. Generally, the radio frequency unit 410 includes, but is not limited to, an antenna, at least one amplifier, a transceiver, a coupler, a low noise amplifier, a duplexer, and the like. In addition, the radio frequency unit 410 may further communicate with another device by using a wireless communication system and network.

The terminal provides a user with wireless broadband Internet access through the network module 420, for example, helps the user send and receive emails, browse web pages, and access streaming media.

The audio output unit 430 may convert audio data received by the radio frequency unit 410 or the network module 420 or stored in the memory 490 into an audio signal and output the audio signal as a sound. Moreover, the audio output unit 430 may further provide an audio output (for example, call signal receiving sound and message receiving sound) related to a specific function performed by the terminal 40. The audio output unit 430 includes a loudspeaker, a buzzer, a telephone receiver, and the like.

The input unit 440 is configured to receive an audio signal or a video signal. The input unit 440 may include a graphics processing unit (GPU) 441 and a microphone 442. The graphics processing unit 441 processes image data of a static image or a video obtained by an image capture apparatus (such as, a camera) in a video capture mode or an image capture mode. A processed image frame may be displayed on the display unit 460. The image frame processed by the graphics processing unit 441 can be stored in the memory 490 (or another storage medium) or sent by the radio frequency unit 410 or the network module 420. The microphone 442 can receive sound, and can process such sound into audio data. Processed audio data can be converted, in telephone call mode, into a format that can be sent to a mobile communication network device via the radio frequency unit 410 for output.

The terminal 40 further includes at least one sensor 450, such as a light sensor, a motion sensor, and other sensors. Specifically, the light sensor includes an ambient light sensor and a proximity sensor, where the ambient light sensor can adjust brightness of the display panel 461 depending on luminance of ambient light, and the proximity sensor can turn off the display panel 461 and/or backlight when the terminal 40 moves near the ear. As a type of motion sensor, an accelerometer sensor can detect accelerations in all directions (generally three axes), and can detect the magnitude and direction of gravity when it is still. The accelerometer sensor may be configured to identify a terminal posture (for example, switching between a landscape mode and a portrait mode, related games, and magnetometer posture calibration), perform vibration identification-related functions (for example, a pedometer and a knock), and the like. The sensor 450 may further include a fingerprint sensor, a pressure sensor, an iris sensor, a molecular sensor, a gyroscope, a barometer, a hygrometer, a thermometer, an infrared sensor, and the like. Details are not described herein again.

The display unit 460 is configured to display information input by a user or information provided to a user. The display unit 460 may include a display panel 461, and the display panel 461 may be configured in a form of a liquid crystal display (LCD), an organic light-emitting diode (OLED), or the like.

The user input unit 470 can be configured to receive input numeric or character information, and generate key signal inputs related to user settings and function control of the terminal. Specifically, the user input unit 470 includes a touch panel 471 and another input device 472. The touch panel 471, also called a touch screen, can collect a touch operation of the user on or near the touch panel 471 (For example, the user uses any suitable object or accessory such as a finger or a stylus to operate on or near the touch panel 471). The touch panel 471 may include two parts: a touch detection apparatus and a touch controller. The touch detection apparatus detects a touch position of the user, detects a signal brought by the touch operation, and sends the signal to the touch controller. The touch controller receives touch information from the touch detection apparatus, converts the touch information into touch point coordinates, sends the touch point coordinates to a processor 411, and receives and executes a command sent by the processor 411. In addition, the touch panel 471 may be implemented by using a plurality of types such as a resistive type, a capacitive type, an infrared ray, and a surface acoustic wave. In addition to the touch panel 471, the user input unit 470 may also include the another input device 472. Specifically, the another input device 472 may include, but is not limited to, a physical keyboard, functional keys (for example, a volume control key and a switch key), a trackball, a mouse, and a joystick. Details are not described herein again.

Further, the touch panel 471 may cover the display panel 461. When the touch panel 471 detects a touch operation on or near the touch panel 471, the touch operation is transmitted to the processor 411 to determine a type of a touch event, and then the processor 411 provides corresponding visual output on the display panel 461 according to the type of the touch event. Although in FIG. 4, the touch panel 471 and the display panel 461 are two independent components for implementing input and output functions of the terminal, in some embodiments, the touch panel 471 and the display panel 461 may be integrated to implement the input and output functions of the terminal. Details are not limited herein.

The interface unit 480 is an interface connecting an external apparatus to the terminal 40. For example, the external apparatus may include a wired or wireless headset port, an external power supply (or a battery charger) port, a wired or wireless data port, a memory card port, a port for connecting an apparatus having an identification module, an audio input/output (I/O) port, a video I/O port, a headset port, and the like. The interface unit 480 may be configured to receive an input (for example, data information and power) from an external apparatus and transmit the received input to one or more elements within the terminal 40, or may be configured to transmit data between the terminal 40 and the external apparatus.

The memory 490 may be configured to store software programs and various data. The memory 490 may mainly include a program storage area and a data storage area. The program storage area may store an operating system, an application program required by at least one function (such as a sound playback function and an image playback function), and the like. The data storage area may store data (such as audio data and a phone book) created based on use of the mobile phone, and the like. In addition, the memory 490 may include a high-speed random access memory or a nonvolatile memory, for example, at least one disk storage device, a flash memory, or another volatile solid-state storage device.

The processor 411 is a control center of the terminal. The processor 411 uses various interfaces and lines to connect the various parts of the entire terminal, and performs various functions of the terminal and processes data by running or executing software programs and/or modules stored in the memory 490 and invoking data stored in the memory 490, to monitor the terminal as a whole. The processor 411 may include one or more processing units. Optionally, the processor 411 may integrate an application processor and a modem processor. The application processor mainly deals with an operating system, a user interface, an application program, and the like. The modem processor mainly deals with wireless communication. It may be understood that alternatively, the modem processor may not be integrated into the processor 411.

The terminal 40 may further include a power supply 412 (for example, a battery) that supplies power to various components. Optionally, the power supply 412 may be logically connected to the processor 411 through a power supply management system, to perform functions of managing charging, discharging, and power consumption through the power supply management system.

In addition, the terminal 40 includes some function modules not shown, and details are not described herein again.

Optionally, an embodiment of the present disclosure further provides a terminal, including a processor 411, a memory 490, and a program stored in the memory 490 and executable on the processor 411. When the program is executed by the processor 411, each process of the embodiment of the foregoing terminal camping method applied to the terminal side can be implemented, and a same technical effect can be achieved. To avoid repetition, details are not described herein again.

An embodiment of the present disclosure further provides a computer-readable storage medium, which stores a program, where when the program is executed by a processor, each process of the embodiment of the foregoing terminal camping method applied to the terminal side is implemented, and the same technical effects can be achieved. To avoid repetition, details are not described herein again. The computer-readable storage medium is, for example, a read-only memory (ROM), a random access memory (RAM), a magnetic disk, or an optical disc.

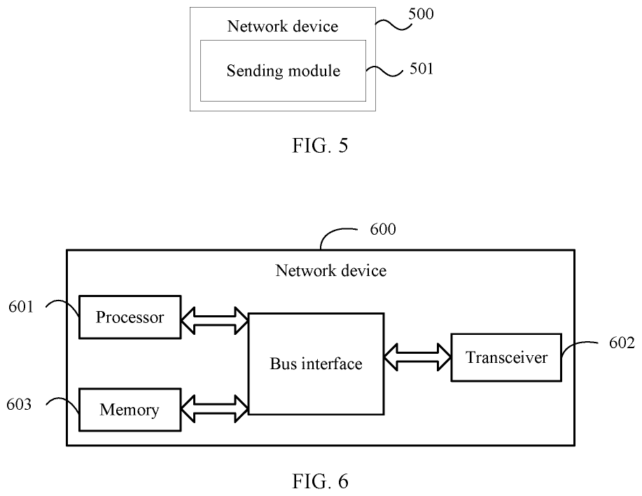

As shown in FIG. 5, an embodiment of the present disclosure further provides a network device 500, including:

a sending module 501, configured to send assistance information to a terminal.

The assistance information is used by the terminal to perform cell reselection and camping when the terminal is in an inactive state and has first uplink data.

Specifically, the sending module is configured to:

before the terminal enters the inactive state, send the assistance information to the terminal; or

after the terminal enters the inactive state, send the assistance information to the terminal.

Further, the sending module is configured to execute at least one of the following manners:

sending a suspending message to the terminal, where the suspending message carries the assistance information; or

broadcasting the assistance information to the terminal.

It should be noted that the network device is a master base station or a secondary base station.

It should be noted that this embodiment of the network device provides the network device corresponding to the information transmission method applied to the network device, all implementations in the foregoing embodiments are applicable to this embodiment of the network device, and the same technical effect thereof can be achieved.

An embodiment of the present disclosure further provides a network device, including: a memory, a processor, and a program stored in the memory and executable on the processor, where the program, when executed by the processor, implements the processes of the embodiment of the information transmission method applied to the network device, and the same technical effects can be achieved. To avoid repetition, details are not described herein again.

An embodiment of the present disclosure further provides a computer-readable storage medium, where the computer-readable storage medium stores a program, the program, when executed by the processor, implements the processes of the embodiment of the information transmission method applied to the network device, and the same technical effects can be achieved. To avoid repetition, details are not described herein again. The computer-readable storage medium is, for example, a ROM, a RAM, a magnetic disk, or an optical disk.

FIG. 6 is a structural diagram of a network device according to an embodiment of the present disclosure. The network device can implement details of the information transmission method, and achieve the same effect. As shown in FIG. 6, a network device 600 includes: a processor 601, a transceiver 602, a memory 603, and a bus interface.

The processor 601 is configured to read a program in the memory 603 to perform the following process:

sending assistance information to a terminal by using the transceiver 602, where

The assistance information is used by the terminal to perform cell reselection and camping when the terminal is in an inactive state and has first uplink data.

In FIG. 6, a bus architecture may include any quantity of interconnected buses and bridges, which are specifically connected together by various circuits of one or more processors represented by the processor 601 and a memory represented by the memory 603. The bus architecture may further connect together various other circuits of a peripheral device, a voltage stabilizer, a power management circuit, and the like, which are known in this art and will not be further described herein. The bus interface provides an interface. The transceiver 602 can include a plurality of elements, namely a transmitter and a receiver, providing units in communication with various other devices on the transmission medium.

The processor 601 is responsible for management of the bus architecture and general processing. The memory 603 may store data used by the processor 601 when operations are performed.

Optionally, the processor 601 is configured to read a program in the memory 603 to perform the following process:

before the terminal enters the inactive state, sending the assistance information to the terminal; or

after the terminal enters the inactive state, sending the assistance information to the terminal.

Optionally, the processor 601 is configured to read a program in the memory 603 to perform the following process:

sending a suspending message to the terminal, where the suspending message carries the assistance information; or

broadcasting the assistance information to the terminal.

The network device is a master base station or a secondary base station, and the master base station or the secondary base station may be a base transceiver station (BTS) in global system for mobile communications (GSM) or code division multiple access (CDMA), or may be a NodeB (NB) in wideband code division multiple access (WCDMA), or may be an evolved NodeB (eNB or eNodeB) in LTE, or a relay station or an access point, or a base station in the future 5G network. This is not limited herein.

The optional implementations of the present disclosure are described above. It should be noted that persons of ordinary skill in the technical field may further make several improvements and refinements without departing from the principles described in the present disclosure, and these improvements and refinements also fall within the protection scope of the present disclosure.

What is claimed is:

1. A terminal camping method, applied to a terminal and comprising:
obtaining assistance information for cell reselection and camping; and
when the terminal is in an inactive state, performing cell reselection and camping according to first uplink data and the assistance information, wherein
the first uplink data comprises at least one of uplink data of a secondary base station or uplink data of a master base station.

2. The terminal camping method according to claim 1, wherein obtaining the assistance information for cell reselection and camping comprises:
before entering the inactive state, obtaining the assistance information for cell reselection and camping; or
after entering the inactive state, obtaining the assistance information for cell reselection and camping.

3. The terminal camping method according to claim 1, wherein obtaining the assistance information for cell reselection and camping comprises one of the following manners:
obtaining the assistance information carried in a suspending message sent by a first base station; or
receiving the assistance information broadcasted by the first base station, wherein the first base station comprises a master base station or a secondary base station.

4. The terminal camping method according to claim 1, wherein performing the cell reselection and camping according to the first uplink data and the assistance information when the terminal is in the inactive state comprises:
when the terminal is in the inactive state, when the first uplink data arrives, if a cell on which the terminal currently camps cannot transmit the first uplink data, performing the cell reselection and camping according to the first uplink data and the assistance information.

5. The terminal camping method according to claim 4, wherein, when the first uplink data arrives, if the cell on which the terminal currently camps cannot transmit the first uplink data, before performing the cell reselection and camping according to the first uplink data and the assistance information, the method further comprises:
storing the assistance information when the terminal is in the inactive state.

6. The terminal camping method according to claim 4, wherein performing the cell reselection and camping according to the first uplink data and the assistance information, when the first uplink data is the uplink data of the master base station and if a cell on which the terminal currently camps cannot transmit the first uplink data, comprises:
if the terminal in the inactive state camps on a cell of a non-master base station, reselecting and camping on a cell of the master base station according to the first uplink data and the assistance information; or
if the terminal in the inactive state camps on a cell of a non-secondary base station, reselecting and camping on a cell of the secondary base station according to the first uplink data and the assistance information.

7. The terminal camping method according to claim 1, wherein performing the cell reselection and camping according to the first uplink data and the assistance information comprises:
according to the first uplink data, determining at least one first candidate cell for reselection and camping; and
reselecting a first cell from the at least one first candidate cell by using assistance information configured for the at least one first candidate cell, and camping on the first cell.

8. The terminal camping method according to claim 1, wherein the assistance information comprises at least one of offset information of cell reselection parameter or cell reselection priority information.

9. The terminal camping method according to claim 8, wherein the assistance information is a cell-specific configuration or a frequency-specific configuration.

10. An information transmission method applied to a network device, comprising:
sending assistance information to a terminal, wherein
the assistance information is used by the terminal to perform cell reselection and camping when the terminal is in an inactive state and has first uplink data.

11. The information transmission method according to claim 10, wherein sending the assistance information to the terminal comprises:
before the terminal enters the inactive state, sending the assistance information to the terminal; or
after the terminal enters the inactive state, sending the assistance information to the terminal.

12. The information transmission method according to claim 10, wherein sending the assistance information to the terminal comprises:
sending a suspending message to the terminal, wherein the suspending message carries the assistance information; or
broadcasting the assistance information to the terminal.

13. A terminal, comprising a memory, a processor, and a program stored in the memory and executable on the processor, wherein the program, when executed by the processor, causes the processor to:
obtain assistance information for cell reselection and camping; and
when the terminal is in an inactive state, perform cell reselection and camping according to first uplink data and the assistance information, wherein
the first uplink data comprises at least one of uplink data of a secondary base station or uplink data of a master base station.

14. The terminal according to claim 13, wherein the program, when executed by the processor, further causes the processor to:
before entering the inactive state, obtain the assistance information for cell reselection and camping; or
after entering the inactive state, obtain the assistance information for cell reselection and camping.

15. The terminal according to claim 13, wherein, to obtain the assistance information for cell reselection and camping, the program, when executed by the processor, causes the processor to:
obtain the assistance information carried in a suspending message sent by a first base station; or
receive the assistance information broadcasted by the first base station, wherein the first base station comprises a master base station or a secondary base station.

16. The terminal according to claim 13, wherein the program, when executed by the processor, further causes the processor to:
when the terminal is in the inactive state, when the first uplink data arrives, if a cell on which the terminal currently camps cannot transmit the first uplink data, perform the cell reselection and camping according to the first uplink data and the assistance information.

17. The terminal according to claim 16, wherein, when the first uplink data is uplink data of the master base station, the program, when executed by the processor, further causes the processor to:
if the terminal in the inactive state camps on a cell of a non-master base station, reselect and camp on a cell of the master base station according to the first uplink data and the assistance information.

18. The terminal according to claim 16, wherein, when the first uplink data is uplink data of the secondary base station, the program, when executed by the processor, further causes the processor to:
if the terminal in the inactive state camps on a cell of a non-secondary base station, reselect and camp on a cell of the secondary base station according to the first uplink data and the assistance information.

19. The terminal according to claim 13, wherein the program, when executed by the processor, further causes the processor to:
according to the first uplink data, determine at least one first candidate cell for reselection and camping; and
reselect a first cell from the at least one first candidate cell by using the assistance information configured for the at least one first candidate cell, and camp on the first cell.

20. The terminal according to claim 13, wherein the assistance information comprises at least one of offset information of cell reselection parameter or cell reselection priority information.
